(19) United States
(12) Patent Application Publication
(10) Pub. No.: US 2023/0241712 A1
(43) Pub. Date: Aug. 3, 2023

(54) Laser Processing Apparatus

(71) Applicant: Nippon Telegraph and Telephone Corporation, Tokyo (JP)

(72) Inventors: Yuichi Akage, Tokyo (JP); Soichi Oka, Tokyo (JP); Masahiro Ueno, Tokyo (JP); Takashi Sakamoto, Tokyo (JP); Sohan Kawamura, Tokyo (JP); Yurina Tanaka, Tokyo (JP)

(21) Appl. No.: 18/002,910

(22) PCT Filed: Jul. 1, 2020
(86) PCT No.: PCT/JP2020/025808

§ 371 Date: Dec. 22, 2022

(51) Int. Cl. B23K 26/064

(52) U.S. Cl. CPC B23K 26/064

(57) ABSTRACT

A laser processing apparatus includes a plurality of laser sources, an optical fiber connected to each of the plurality of laser sources, the optical fiber being one of a plurality of the optical fibers, and diffractive optical elements on which laser light beams are incident, laser light beams being emitted from the plurality of optical fibers. Diffracted light reflected by each of the diffractive optical elements forms an image on an object at a substantially identical intensity distribution and at a substantially identical focal position.

### CROSS-REFERENCE TO RELATED APPLICATIONS

This application is a national phase entry of PCT Application No. PCT/JP2020/025808, filed on Jul. 1, 2020, which application is hereby incorporated herein by reference.

### TECHNICAL FIELD

The present invention relates to a laser processing apparatus using laser light transmitted through an optical fiber.

### BACKGROUND

There is an increasing use of an apparatus utilizing a high-power laser in processing a metal material, for example, cutting, drilling, and welding a metal material. Such a laser processing apparatus can locally concentrate high energy and can perform non-contact processing on the metal material, and thus, it is possible to finely process such a material and suppress an influence of heat. Fiber lasers with increased high power are applied for improving a processing throughput in mass production factories and are applied to processing of large structural materials.

In addition to the high power of laser, a peripheral technique for high performance of the laser processing apparatus has also been actively researched and developed for the laser processing apparatus. An optical fiber through which the laser is transmitted, serving as a fiber supporting high-power laser now can transmit kilowatt (kW) class lasers from several tens to several hundreds of meters to realize a work with few restrictions on the position of a laser source.

In a technique for controlling a shape of a laser beam and irradiating a material to be processed with the resultant laser beam, a technique is actively developed for increasing the freedom of a laser irradiation pattern by using not only a combination of a concave lens, a convex lens, a prism, and the like but also a diffractive optical element (DOE) (see PTL 1).

In the laser irradiation pattern technique using the DOE, various techniques have been developed including a technique for uniformly irradiating a large area with a high-power laser beam to shorten a processing time and a technique for achieving a uniform power distribution in the beam at a focal point to effectively dismantle large structures and process composite materials.

In a laser processing apparatus using such a diffractive optical element (DOE), as illustrated in FIG. 5, laser light emitted from one high-power laser source 51 is incident onto a diffractive optical element 55 via an optical fiber 52, and an object 101 is irradiated with the reflected (diffracted) light 2 for processing.

### CITATION LIST

### Patent Literature

PTL 1: JP 2019-203960 A

### Non Patent Literature

NPL 1: https://www.ntt.co.jp/journal/1904/files/pdf/JN201904all.pdf SUMMARY

### Technical Problem

Unfortunately, transmitting high-power laser light through the optical fiber causes not only a short transmission distance, but also the bending limit of the optical fiber. When the optical fiber is bent, an influence of a light leakage and the like at the bent part leads to heat generation to damage the optical fiber.

Furthermore, an optical component such as a diffractive optical element (DOE) generates heat due to incidence of the high-power laser light to cause misalignment, and as a result, the focus is displaced.

### Means for Solving the Problem

In order to solve the problem described above, a laser processing apparatus according to embodiments of the present invention includes a plurality of laser sources, an optical fiber connected to each of the plurality of laser sources, the optical fiber being one of a plurality of the optical fibers, and diffractive optical elements on which a plurality of laser light beams are incident, the plurality of laser light beams being emitted from the plurality of optical fibers. Diffracted light reflected by each of the diffractive optical elements forms an image on an object at a substantially identical intensity distribution and at a substantially identical focal position.

### Effects of Embodiments of the Invention

According to embodiments of the present invention, it is possible to provide a laser processing apparatus using high-power laser light transmitted through an optical fiber over a long distance.

### BRIEF DESCRIPTION OF THE DRAWINGS

FIG. 1 is a schematic view of a laser processing apparatus according to a first embodiment of the present invention.

FIG. 2 is a schematic view of a laser processing apparatus according to a second embodiment of the present invention.

FIG. 3 is a schematic view of a laser processing apparatus according to a third embodiment of the present invention.

FIG. 4 is a schematic view of transmission-type diffractive optical elements in the laser processing apparatus according to the first embodiment of the present invention.

FIG. 5 is a schematic view of a known laser processing apparatus.

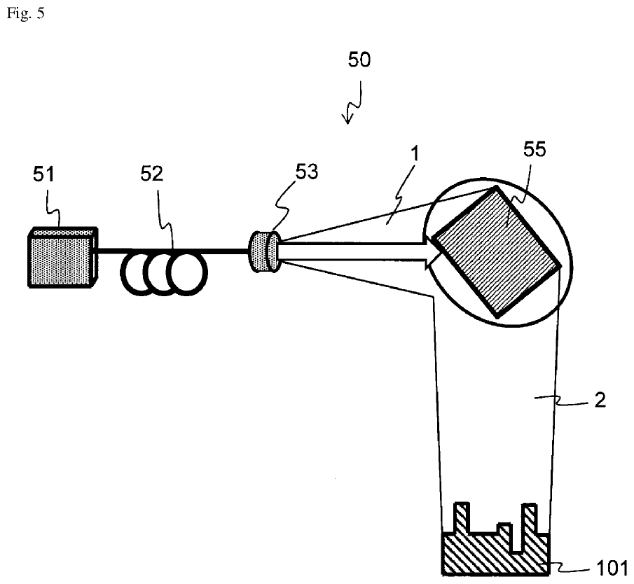

### DETAILED DESCRIPTION OF ILLUSTRATIVE EMBODIMENTS

### First Embodiment

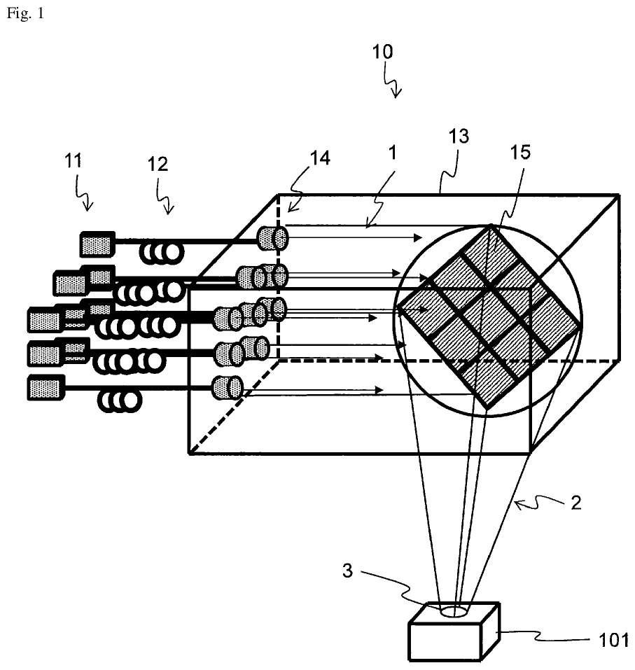

A first embodiment of the present invention will be described with reference to FIG. 1.

Configuration of Laser Processing Apparatus

FIG. 1 illustrates a laser processing apparatus 10 according to the first embodiment.

The laser processing apparatus 10 includes laser sources 11, optical fibers 12, and a laser head 13.

The laser sources 11 include nine fiber lasers arranged in parallel. Output of each laser source 11 is 1 kW, and a wavelength of the laser light is 1064 to 1070 nm. One of the laser sources 11 is approximately 15 cm by 40 cm in size of the end surface on an emission end side and 40 cm in length, and the laser sources are fixed at a predetermined position for use.

Each of the optical fibers 12 propagates the output of each laser source 11. The length of the optical fiber 12 is 100 m. A collimating lens 14 is mounted at a distal end of the optical fiber 12. The collimating lens 14 emits the output from each optical fiber 12 as a parallel beam.

The laser head 13 is connected with the distal end of the optical fiber 12 and includes diffractive optical elements (DOEs) 15. The shape of the laser head 13 is a rectangular parallelepiped having each side of approximately 10 cm to 20 cm.

The diffractive optical elements (DOEs) 15 are of reflective type and include nine elements in accordance with the number of laser sources. Laser light 1 emitted via the optical fiber 12 from the nine laser sources are reflected by each of the nine elements to come into focus on a surface of an object.

The diffractive optical elements 15 each have a dimension of approximately 15 mm×15 mm and are formed by being integrated on one substrate. A fine concavo-convex structure is formed on the surface of each of the diffractive optical elements 15. Gold, silver, copper, aluminum, or silicon carbide, diamond, aluminum nitride, silicon, and the like may be employed for a material of the diffractive optical elements 15 (substrate), and a material having good heat conduction is desirable.

Here, a distance from the distal end of the optical fiber 12 to the diffractive optical elements 15 is approximately 10 cm, and a distance from the diffractive optical elements 15 to the object can be freely designed depending on the design of the concavo-convex structure of the diffractive optical elements, and for example, such a distance is designed to be approximately several tens of centimeters to wo cm in the laser processing apparatus and the like.

The laser light 1 emitted from the distal end of the optical fiber 12 has a plane wave with a wave surface being a straight line perpendicular to a direction of travel, and has the Gaussian distribution in intensity. The laser light 1 is reflected and diffracted by the diffractive optical elements 15, and diffracted light 2 forms an image on the surface of the object 101 to process the object 101.

At this time, the concavo-convex structure formed on the surface of each of the diffractive optical elements 15 can form a shape of a cross section of a beam 3 of the light and a light intensity distribution at the focal position. Hereinafter, the concavo-convex structure includes a concavo-convex shape and a concavo-convex layout (arrangement).

When a predetermined concavo-convex structure is thus provided on the surface of each of the diffractive optical elements 15, light beams (diffracted light beams) 2 diffracted by such a concavo-convex structure form an image in a predetermined pattern on the surface of the object 101. As a result, a plurality of predetermined patterns are overlapped to form an image. In other words, it is possible to design the concavo-convex structure on the surface of each of the diffractive optical elements 15 so that the light beams form an image in a predetermined pattern on the surface of the object 101.

In the present embodiment, the concavo-convex structure on the surface of each of the diffractive optical elements 15 is designed so that each of the light beams 2 diffracted by the nine diffractive optical elements 15 has a uniform intensity distribution within the beams 3 focused on the surface of the object 101 and forms an image with the substantially identical intensity distribution and at the substantially identical focal position. Here, a shape of the beams 3 forming an image on the surface of the object 101 is a rectangle of approximately 0.2 mm×0.2 mm or a circle of approximately 0.2 mm in diameter.

In a known art, if a plurality of laser sources and a plurality of optical components such as lenses or mirrors are used without using a diffractive optical element, the intensity distribution within the beam forming an image on the surface of the object 101 is ununiform. As a result, when a plurality of beams are overlaid and processed, it is difficult to focus each beam and increase the light intensity in a predetermined area.

On the other hand, according to the present embodiment, each beam has a uniform intensity distribution, and thus, it is possible to easily focus each beam and increase the light intensity in a predetermined area to perform laser processing.

Effect of Laser Processing Apparatus

An effect of the laser processing apparatus 10 according to the present embodiment will be described.

A transmittable distance of a high-power laser through an optical fiber is estimated based on the product of the laser output and the distance. For example, if the product of the laser output and the distance is 300 km·W, an optical fiber transmission distance of a laser processing apparatus with a single laser source and an output of 6.3 kW is estimated to be 300÷ 6.3=47.6 m.

Thus, in a known 10 kW-class laser processing apparatus, a distance from the laser source to a laser head is limited to several tens of meters at most.

If high-power laser light of about 10 kW is propagated through an optical fiber, bending the optical fiber causes heat generation due to an influence of a light leakage and the like at the bent part to damage the optical fiber, and thus, there is a limitation such as a bending radius of the optical fiber not being reduced to several tens of centimeters or less.

On the other hand, in the laser processing apparatus according to the present embodiment, the light source includes nine laser sources, and thus, if output of one laser source is 1 kW, laser light having a total of 9 kW is emitted. The laser light to be emitted enters the object with irradiation with an output of 6.3 kW in consideration of a pattern conversion loss (approximately 30%) on the DOE elements. The transmission distance for one laser beam at this time is 300÷ 1=300 m.

Thus, in consideration of the transmission distance of the fiber of the known laser processing apparatus, the fiber of the laser processing apparatus according to the present embodiment has a length of 50 m or greater to exhibit an effect, and desirably has a length of from 100 m to 300 m.

Furthermore, the output of the laser light beams propagating through the optical fiber is approximately 1 kW, and thus, it is possible to prevent the damage caused by heat generated at the bent part of the optical fiber.

Thus, in the laser processing apparatus according to the present embodiment, it is possible to extend the transmission distance of the optical fiber, and thus, it is possible to extend the distance from the laser source to the laser head in the laser processing apparatus with an output of 10 kW. As a result, it is possible to utilize an optical fiber of several hundreds of meters to increase the freedom of a bending radius of the optical fiber to prevent a risk including a breakage of the optical fiber caused by the heat generation due to an optical loss in the optical fiber.

In addition, according to the laser processing apparatus of the present embodiment, when the output is divided by a plurality of laser sources, for example, even if some of constituent components such as an optical fiber and a DOE element fail in each route through which light beams emitted from the nine laser sources propagate, it is still possible to operate another route not including the failed component. Thus, it is possible to perform laser processing by keeping a decrease in a total laser output as small as possible. As a result, it is possible to perform component replacement and maintenance work while maintaining the throughput of the laser processing.

In addition, it is possible to combine individual laser outputs to achieve a predetermined laser processing output, and thus, it is possible to easily adjust the laser output and regularly maintain a laser source and the like to achieve a highly redundant utilization.

As described above, the laser processing apparatus according to the present embodiment is capable of diffracting and processing the laser light with the diffractive optical element from a plurality of laser sources remotely disposed via the optical fiber and a small laser head, and thus, it is possible to perform a laser processing work by introducing the laser light into an enclosed space, for example, in an abandoned space or in a tank of a ship.

In addition, the laser processing apparatus according to the present embodiment is small and lightweight to be mounted on a robot arm, and thus, a laser processing work can be performed in a remote operation in an enclosed space.

If a single laser source is used, an optical component such as a diffractive optical element (DOE) generates heat due to the incidence of the high-power laser light to cause misalignment, and as a result, the focus is displaced. According to the laser processing apparatus of the present embodiment, the output is divided by a plurality of laser sources, and thus, the high-power laser light is not incident on the optical components such as the diffractive optical element (DOE). As a result, it is possible to prevent positional displacement of the optical components due to the heat generation and also prevent the focal displacement.

In the present embodiment, a material having good heat conduction is employed for the material of the diffractive optical element (DOE), and thus, it is possible to further prevent the effect of the heat generation.

### Second Embodiment

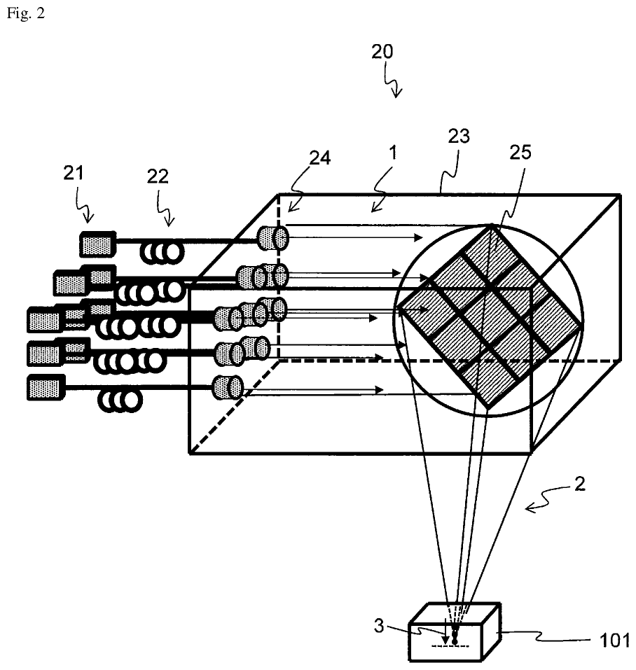

A laser processing apparatus according to a second embodiment of the present invention will be described with reference to FIG. 2. The laser processing apparatus according to the present embodiment is configured in much the same way as the laser processing apparatus according to the first embodiment to exhibit a substantially similar effect, but differs in focal position of the diffracted light on the object.

Configuration of Laser Processing Apparatus

FIG. 2 illustrates a laser processing apparatus 20 according to the second embodiment.

The laser processing apparatus 20 includes laser sources 21, optical fibers 22, and a laser head 23, and the laser head 23 is connected with a distal end of the optical fiber 22, and includes diffractive optical elements (DOEs) 25.

Here, when a predetermined concavo-convex structure is provided on the surface of each of the diffractive optical elements 25, each light beam (diffracted light beam) 2 diffracted by such a concavo-convex structure forms an image in a predetermined pattern on the surface of the object 101. As a result, a plurality of predetermined patterns are overlapped to form an image. In other words, it is possible to design the concavo-convex structure on the surface of each of the diffractive optical element 25 so that the light beams form an image in a predetermined pattern on the surface of the object 101.

In the present embodiment, the concavo-convex structure on the surface of each of the diffractive optical elements 25 is designed so that beams 3 forming an image on the surface of the object 101 for the diffracted light 2 each have a focus located across a predetermined depth of the object 101. As a result, the focuses are located at regular intervals across a depth of approximately 10 mm from the surface of the object 101.

Thus, in the present embodiment, the concavo-convex structure on the surface of each of the diffractive optical elements 25 is designed so that each of the light beams 2 diffracted by the nine diffractive optical elements 25 forms an image at a predetermined substantially identical focal position within a depth direction of the object 101, and thus, it is also possible to control the beam in a far direction of a processed surface (depth direction of the object 101).

Thus, according to the present embodiment, it is possible to perform the laser processing so that the beams each have a focus located across a predetermined depth of the object. As a result, it is possible to efficiently process the object across a predetermined depth of the object, and thus, it is possible to perform high-speed processing (cutting) of a structural object and the like having a thick layer.

As described above, the laser processing apparatus according to the present embodiment is capable of diffracting and processing the laser light with the diffractive optical element from a plurality of laser sources disposed remotely via the optical fiber and a small laser head, and thus, it is possible to perform a laser processing work by introducing the laser light into an enclosed space, for example, in a furnace or in a tank of a ship.

### Third Embodiment

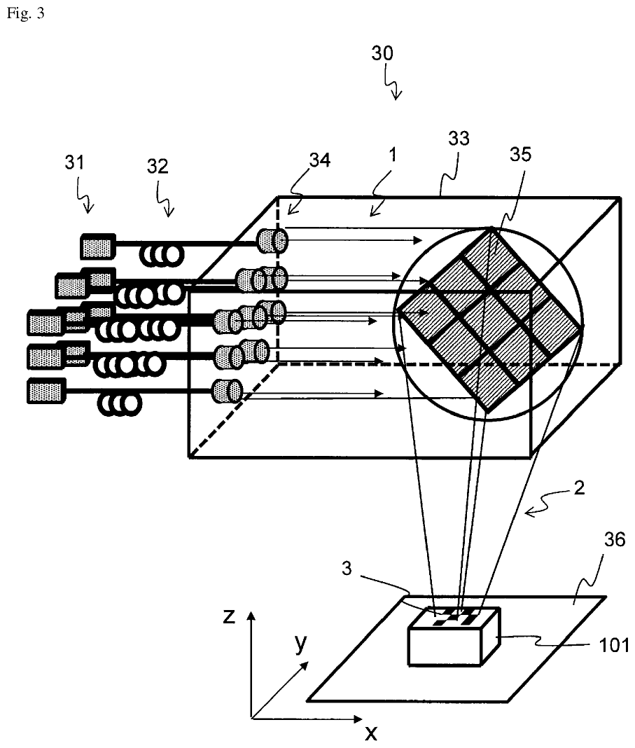

A laser processing apparatus according to a third embodiment of the present invention will be described with reference to FIG. 3. The laser processing apparatus according to the present embodiment is configured in much the same way as the laser processing apparatus according to the first embodiment to exhibit a substantially similar effect, but differs in provision of a movable stage. The details will be described below.

Configuration of Laser Processing Apparatus

FIG. 3 illustrates a laser processing apparatus 30 according to the third embodiment.

The laser processing apparatus 30 includes laser sources 31, optical fibers 32, a laser head 33, diffractive optical elements 35, and a stage 36 on which the object (object to be processed) 101 is placed.

The object 101 is placed on the stage 36, and when the stage 36 is driven by an electricity and the like from outside in a horizontal direction (an x direction and a y direction), the focal position on the object 101 to be irradiated with the beam 3 is moved to process the object 101. Here, the stage may be driven in a vertical direction (z direction).

The laser light 1 emitted from each of the optical fibers is a plane wave having a wave surface being a straight line perpendicular to a direction of travel, and has the Gaussian distribution in intensity. The laser light is reflected by the diffractive optical elements 35 to generate diffracted light 2 so that an image is formed on the surface of the object 101 to process the object 101.

When the stage is driven with the image of the diffracted light being thus formed on the object, the focus of a diffraction grating moves within the object, and as a result, the object is processed.

Here, when a predetermined concavo-convex structure is provided on the surface of each of the diffractive optical elements 35, each light beam (diffracted light beam) 2 diffracted by such a concavo-convex structure forms an image in a predetermined pattern on the surface of the object 101. As a result, a plurality of predetermined patterns are overlapped to form an image. In other words, it is possible to design the concavo-convex structure on the surface of each of the diffractive optical elements 35 so that the light beams form an image in a predetermined pattern on the surface of the object 101. A pattern of an image formed on the surface of the object can include a variety of patterns such as a circle, a rectangle, and a ring shape.

In the present embodiment, it is possible to design the concavo-convex structure on the surface of each of the diffractive optical elements so that beams forming an image on the surface of the object shapes a plurality of predetermined patterns.

Thus, in the present embodiment, the concavo-convex structure on the surface of the diffractive optical elements 15 is designed so that each of the light beams diffracted by the diffractive optical elements forms an image on the surface of the object in a plurality of predetermined patterns (shapes).

In the known technique, if a plurality of optical components such as lenses or mirrors are employed for a plurality of laser sources without using the diffractive optical element to superimpose a plurality of beams to perform processing, it is necessary to perform a complicated adjustment of the optical system along with a large number of optical components.

On the other hand, according to the present embodiment, each beam has a plurality of predetermined patterns, and thus, it is possible to combine the plurality of predetermined patterns to easily perform laser processing with high accuracy of from submicron to several microns.

Thus, the laser processing apparatus according to the present embodiment is capable of performing laser processing with high accuracy by diffracting the laser light by the diffractive optical element via the optical fiber and the small laser head from a plurality of laser sources remotely disposed.

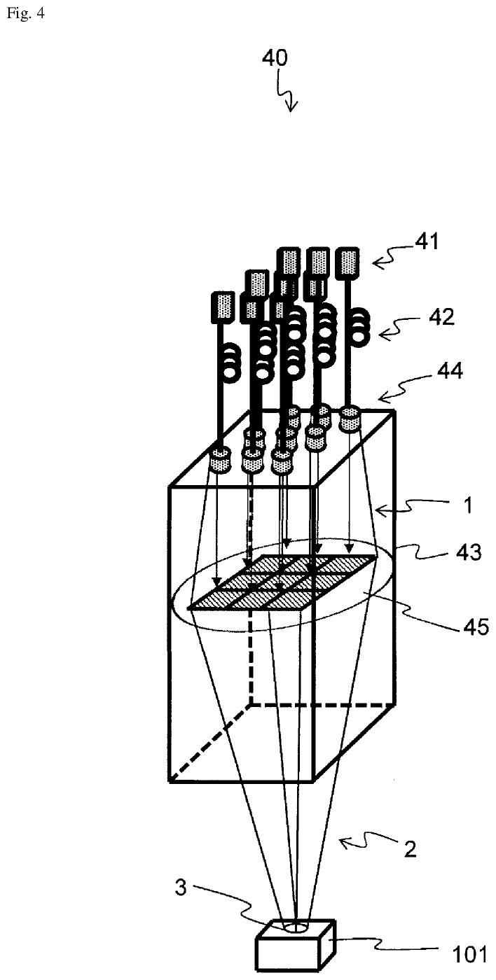

In the embodiment of the present invention, the reflective-type diffractive optical elements are employed; however, a transmission-type diffractive optical elements may be employed as illustrated in FIG. 4.

In the embodiments of the present invention, the nine laser sources are used; however, the number of laser sources is not limited and a plurality of laser sources are simply required to be used. The example where the nine laser sources are arranged in parallel is described; however, the present invention is not limited to such a parallel arrangement, and any arrangement allowing the laser light to be incident on the diffractive optical element via the optical fiber may be employed.

Here, the laser source employed in the embodiments of the present invention provides output of up to 5 kW because the output of 10 kW of the known high-power laser is divided by a plurality (at least two) of laser sources. In consideration of the processing of the object formed of a metal, a resin, or the like, the output of 0.5 kW is required. Thus, the output of the laser source used in the embodiment of the present invention is desirably from 0.5 kW to 5 kW.

In the embodiments of the present invention, an example is described where the nine diffractive optical elements are included corresponding to the number of laser sources, but the present invention is not limited thereto, and a plurality of diffractive optical elements may be provided. There is no need to correspond to the number of laser sources, a plurality of laser light beams may be incident on the one diffractive optical element, and the laser light beams may be divided and incident on the plurality of diffractive optical elements.

In the embodiments of the present invention, an example is described where the nine diffractive optical elements are integrated on one substrate, but the present invention is not limited thereto, and diffractive optical elements may be arranged without being integrated on one substrate.

In the embodiments of the present invention, an example of the structure, dimension, material, and the like of each component in the configuration of the laser processing apparatus, the method of manufacturing the same, and the like has been described; however, the present invention is not limited thereto. Any structure, dimension, material, and the like may be available as long as the apparatus exhibits the functions and effects of the laser processing apparatus.

### INDUSTRIAL APPLICABILITY

Embodiments of the present invention may be applied to processing of metals, resins, and the like in the industrial field and cutting of structural objects in the construction field.

### REFERENCE SIGNS LIST

10 Laser processing apparatus
11 Laser sources
12 Optical fibers
13 Laser head
14 Collimating lens
15 Diffractive optical elements.

1-8. (canceled)

9. A laser processing apparatus, comprising:
a plurality of laser sources;
a plurality of optical fibers, a respective optical fiber of the plurality of optical fibers being connected to each of the plurality of laser sources; and
diffractive optical elements on which a plurality of laser light beams are incident, the plurality of laser light beams being emitted from the plurality of optical fibers, wherein diffracted light reflected by each of the diffractive optical elements forms an image on an object at a substantially identical intensity distribution and at a substantially identical focal position.

10. The laser processing apparatus according to claim 9, wherein an output of each of the plurality of laser sources is in a range from 0.5 kW to 5 kW.

11. The laser processing apparatus according to claim 9, wherein a length of each optical fiber of the plurality of optical fibers is in a range from 50 m to 300 m.

12. The laser processing apparatus according to claim 9, wherein a concavo-convex structure on a surface of each of the diffractive optical elements is configured so that an intensity distribution within a beam is uniform when the diffracted light forms the image on the object.

13. The laser processing apparatus according to claim 12, wherein the concavo-convex structure on the surface of each of the diffractive optical elements is configured so that beams of the diffracted light each have a focus located across a predetermined depth of the object.

14. The laser processing apparatus according to claim 12, further comprising:
a movable stage, wherein the concavo-convex structure on the surface of each of the diffractive optical elements is configured so that the diffracted light forms the image in a predetermined pattern on the object.

15. The laser processing apparatus according to claim 9, wherein the diffractive optical elements are of a reflective type.

16. The laser processing apparatus according to claim 9, wherein the diffractive optical elements are integrated on a single substrate.

17. A method of operating a laser processing apparatus, the method comprising:
emitting, by a plurality of optical fibers, a plurality of laser light beams; and
reflecting, by a plurality of diffractive optical elements, the plurality of laser light beams as diffracted light to form an image on an object at a substantially identical intensity distribution and at a substantially identical focal position, wherein the laser processing apparatus comprises:
a plurality of laser sources;
the plurality of optical fibers, a respective optical fiber of the plurality of optical fibers being connected to each of the plurality of laser sources; and
the plurality of diffractive optical elements on which a plurality of laser light beams are incident.

18. The method according to claim 17, wherein an output of each of the plurality of laser sources is in a range from 0.5 kW to 5 kW.

19. The method according to claim 17, wherein a length of each optical fiber of the plurality of optical fibers is in a range from 50 m to 300 m.

20. The method according to claim 17, wherein a concavo-convex structure on a surface of each of the diffractive optical elements is configured so that an intensity distribution within a beam is uniform when the diffracted light forms the image on the object.

21. The method according to claim 20, wherein the concavo-convex structure on the surface of each of the diffractive optical elements is configured so that beams of the diffracted light each have a focus located across a predetermined depth of the object.

22. The method according to claim 20, further comprising:
a movable stage, wherein the concavo-convex structure on the surface of each of the diffractive optical elements is configured so that the diffracted light forms the image in a predetermined pattern on the object.

23. The method according to claim 17, wherein the diffractive optical elements are of a reflective type.

24. The method according to claim 17, wherein the diffractive optical elements are integrated on a single substrate.
